(19) United States
(12) Patent Application Publication
(10) Pub. No.: US 2018/0156287 A1
(43) Pub. Date: Jun. 7, 2018

(54) DISC BRAKE TORQUE ABUTMENT STRUCTURE

(71) Applicant: AKEBONO BRAKE INDUSTRY CO., LTD, Tokyo (JP)

(72) Inventors: Takaaki Sasaki, Farmington Hills, MI (US); Masaki Uchida, Farmington Hills, MI (US)

(21) Appl. No.: 15/830,573

(22) Filed: Dec. 4, 2017

Related U.S. Application Data
(60) Provisional application No. 62/430,448, filed on Dec. 6, 2016.

(51) Int. Cl. F16D 65/097; F16D 55/228

(52) U.S. Cl. CPC F16D 65/0972; F16D 2055/0066; F16D 55/228

(57) ABSTRACT

A brake system that includes a brake caliper and a brake pad. The brake caliper includes a bridge. The bridge includes a lateral member that connects an inboard side of the brake caliper and an outboard side of the brake caliper. The brake pad includes an upper pad abutment. During forward braking, the brake pad rotates until that the upper pad abutment contacts the lateral member and torque from the brake pad is distributed from the brake pad at least to the inboard side the outboard side of the brake caliper.

### FIELD

These teachings relate to structure for stabilizing a brake pad.

### BACKGROUND

A brake system may be used to decelerate a vehicle. During a brake apply, one or more brake pads are moved into contact with a rotating brake rotor to create a clamping force. The clamping force functions to decelerate the vehicle.

When the brake pads are moved into contact with the rotating brake rotor, torque is applied by the brake rotor onto the brake pads, which causes the brake pads to move, rotate, and/or pivot. Typically, the brake pads move, rotate, and/or pivot in a particular direction that depends on the direction of rotation of the brake rotor, which depends on the direction the vehicle is moving (i.e., forward moving or a reverse moving). Depending on the direction of brake rotor rotation, the torque from the brake pads is typically transmitted or distributed from the leading or trailing abutment end of the brake pads to the corresponding leading and/or trailing end of the brake caliper, which, during certain braking events, such as braking during high vehicle speed conditions, may result in high forces applied to an end of a brake caliper, which may lead to caliper distortion and/or failure.

It may therefore be desirable to provide structure for stabilizing a brake pad so that during forward braking, when a vehicle is moving in a forward direction, torque is transmitted or distributed from one or more brake pad to both the leading and trailing ends of the brake caliper and/or to the entire brake caliper (i.e., leading end, trailing end, inboard side, and outboard side).

For example, rather than transmitting or distributing torque from the one or more brake pad to an end of the brake caliper where the main abutment may be, it may be desirable to provide structure where the main abutment is located at an overhead bridge of the brake caliper so that during a braking event, the torque from the brake pads is transmitted or distributed to at least the inboard and outboard sides of the brake caliper and/or the leading and trailing ends of the brake caliper.

It may also be desirable to provide structure for the brake pads and brake caliper so that the brake pads move, rotate, and/or pivot in a single direction during a braking event, regardless of the direction or rotation of the brake rotor (i.e., during forward braking and reverse braking).

Some known brake systems are disclosed in the following US patent applications, all of which are expressly incorporated by reference herein for all purposes: US 2010/0230220; US 2012/0043168; and US 2010/0243384. Some known brake systems are disclosed in the following US patents, all of which are expressly incorporated by reference herein for all purposes: U.S. Pat. No. 7,458,447; U.S. Pat. No. 7,578,374; U.S. Pat. No. 7,926,631; U.S. Pat. No. 9,193,018; U.S. Pat. No. 9,285,002; U.S. Pat. No. 9,365,193; U.S. Pat. No. 3,920,104; U.S. Pat. No. 4,335,806; U.S. Pat. No. 4,537,292; U.S. Pat. No. 4,773,511; U.S. Pat. No. 4,936,422; U.S. Pat. No. 4,993,520; U.S. Pat. No. 5,467,847; and U.S. D601,473; and U.S. Pat. No. 5,875,873. Some known brake systems are disclosed in the following Foreign References, which are expressly incorporated by reference herein for all purposes: JP 5812257, JP2010-236611, and JP2012-241836.

### SUMMARY

These teachings provide structure for stabilizing one or more brake pads during a braking event, such as during forward braking and/or reverse braking. During a braking event, by stabilizing the brake pad(s), these teachings may advantageously reduce noise, brake pad wear, and/or drag.

These teachings may also advantageously reduce taper wear by reducing self-excited uneven pressure distribution of a brake pad during the braking event.

These teachings provide structure for stabilizing a brake pad so that during forward braking, torque from the inboard and outboard brake pads is transmitted or distributed from the brake pads to the leading and trailing ends of the brake caliper. Advantageously, by transmitting or distributing the torque from the brake pads to the inboard and outboard sides and/or leading and trailing ends of the brake caliper, a need for countermeasures to compensate for uneven brake pad wear or taper wear due to uneven forces that are transmitted or distributed to an end and/or a side of the brake caliper can be reduced or eliminated. For example, in some braking structures or applications, brake pistons are offset towards the trailing end of the brake pad, and/or larger brake pistons are provided at the trailing end of the brake pads to compensate for uneven brake pad wear or taper wear. However, because the structure according to the teachings herein provides for the torque to be generally evenly distributed or transmitted between the leading and trailing ends of the brake caliper, such countermeasures can be reduced or even eliminated. By reducing or eliminating such exemplary countermeasures, cost, weight, and/or complexity of the brake caliper or system can be reduced.

These teachings provide structure for the brake pads so that the brake pads rotate or pivot in a single direction during a braking event regardless of the direction or rotation of the brake rotor. For example, the structure, which may include one or more of the leading and/or trailing pad clips or biasing members, the upper abutment, the leading abutment, the trailing abutment, or a combination thereof, provides for the brake pads to rotate in a clockwise direction during vehicle braking, regardless if the brake rotor is rotating in a counter-clockwise direction or a clock-wise direction.

By ensuring the brake pads rotate in a single direction during vehicle braking regardless of the direction of rotation of the brake rotor, the brake pads can be configured to be better stabilized in the brake caliper, thus reducing the amount of movement of the brake pads in the brake caliper. For example, during a braking event in some braking structures or applications, the brake pads are adapted to at least partially move, rotate, and/or pivot in an up and down direction and a front to back direction. Such movements may lead to uneven brake pad wear and/or noise. However, but stabilizing the brake pads so that during a braking event the brake pads generally do not move up and down, but move tangentially from a leading side to a trailing side during a braking event, brake pad wear and/or noise can be reduced.

These teachings provide a brake pad that includes an upper abutment. The upper abutment, which is the main abutment during forward braking, extends or projects from the pressure plate of the brake pad, is located generally between the leading brake pad abutment and the trailing brake pad abutment, and is adapted to contact an overhead bridge of the brake caliper during forward braking. Accordingly, a majority of the torque is transmitted or distributed from the brake pad to the bridge of the brake caliper during forward braking, which in turn functions to distribute the torque to the entire brake caliper, as opposed to a single end of the brake caliper as may be understood in some prior art structure and applications. By having the upper abutment in the center of the brake pad, the torque may be evenly distributed between the leading and trailing ends of the brake caliper, thus reducing or eliminating uneven loading on the leading or trailing end of the brake caliper, which may advantageously reduce or eliminate brake pad wear.

These teachings provide a bridge that may include a lateral member connected to opposing sides of the brake caliper. The bridge may also include a longitudinal member connected to opposing ends of the brake caliper. The lateral and longitudinal members are connected together so that when the torque is applied from the main abutment of the brake pad(s) to the bridge, the torque is distributed to the opposing sides of the brake caliper and the opposing ends of the brake caliper.

### BRIEF DESCRIPTION OF THE DRAWINGS

FIG. 1 is a perspective view of a brake system.

FIG. 2 is a cross-sectional view of an inboard side of the brake caliper of the system of FIG. 1

FIG. 3 is a side view of a brake pad.

FIG. 4 is a cross-sectional view of a brake caliper and brake pad during forward braking.

FIG. 5 is a cross-sectional view of a brake caliper and brake pad during reverse braking.

FIG. 6 is a detailed, cross-sectional view of part of a brake caliper and brake pad.

### DETAILED DESCRIPTION

This application claims the benefit of U.S. 62/430,448 filed on Dec. 6, 2016, the entire disclosure of which is hereby incorporated by reference herein for all purposes.

These teachings provide a brake system. The brake system may be a disc brake system. The brake system may be a fixed caliper brake system.

The brake caliper may include an inboard side and an outboard side. The brake caliper may function to support one or more brake pistons at the inboard side and/or one or more opposing and corresponding brake pistons at the outboard side. When the brake caliper is installed in the vehicle, the inboard side may be the side closest to the center of the vehicle in a lateral direction. Accordingly, the outboard side may be the side closest to the outside of the vehicle in a lateral direction.

The brake system or brake caliper may comprise any number of brake pistons arranged on the inboard side of the brake rotor. For example, one or more brake pistons may be arranged on the inboard side of the brake rotor, two or more, three or more, four or more, six or more, ten or more, etc. brake pistons may be arranged on the inboard side of the brake rotor. The brake system or brake caliper may comprise any number of brake pistons arranged on the outboard side of the brake rotor. For example, one or more brake pistons may be arranged on the inboard side of the brake rotor, two or more, three or more, four or more, six or more, ten or more, etc. brake pistons may be arranged on the outboard side of the brake rotor.

The brake caliper may include a leading end and a trailing end. The leading end of the brake caliper, sometimes also referred to as the entry end, may be the end of the brake caliper that corresponds to the end of the brake pads that first touch the brake rotor during a braking event. Accordingly, the trailing end, sometimes also referred to as the exit end, is the end of the caliper that corresponds to the end of the brake pads that last touch the brake rotor during a braking event.

As used throughout this disclosure, a braking event may be realized during forward braking or during reverse braking. Forward braking may refer to braking that occurs when a vehicle is traveling in a forward direction (i.e., when a vehicle wheel and brake rotor rotates in a counter-clockwise direction). Conversely, reverse braking may refer to braking that occurs when a vehicle is traveling in a reverse direction (i.e., when the vehicle wheel and brake rotor rotates in a clockwise direction).

A braking event may refer to application of a service brake or standard braking to slow or stop rotation of a brake rotor or road wheel. A braking event may refer to application of a parking brake to restrict or prevent movement of a brake rotor or road wheel.

The braking event may be realized by pressuring fluid, such as hydraulic fluid, to move one or more brake pistons to move one or more brake pads against a brake rotor to create clamping force. The braking event may be realized by turning ON or energizing an electric motor, which may function to move one or more brake pistons to move one or more brake pads against a brake rotor to create clamping force.

Clamping force may be any force that, when coupled with a brake pad coefficient of friction, functions to decelerate, slow, stop, and/or prevent movement or rotation of a moving component. The clamping force may be created during a standard brake apply or application of the service brake (i.e., a brake apply force) to slow, stop, or prevent movement of a moving component, a brake rotor, a road wheel, or vehicle. The clamping force may be created during a parking brake apply (i.e., a parking brake force) to prevent or restrict movement of a stopped or parked moving component, brake rotor, road wheel, or vehicle.

The brake caliper may comprise a bridge. The bridge may comprise a lateral member. The later member may comprise a lateral member edge. The lateral member edge may be generally planar and flat, or the lateral member edge may be at least slightly rounded. The lateral member edge may face the leading end of the brake caliper, or the training end of the caliper. The direction that the edge faces will dictate the rotational direction of the brake pad. The lateral member edge may extend along a plane or edge that is generally centered between the leading and trailing ends of the caliper or along a center line of the brake caliper. The lateral member edge may extend along a plane or edge that is offset towards a leading end of the brake caliper or towards a trailing end of the brake caliper.

The lateral member may contact the inboard side and the outboard side. torque from rotation of the one or more brake pads may be distributed between the inboard and outboard side of a brake caliper via the lateral member. The longitudinal member may contact the leading end and the training end of the brake caliper. Torque from rotation of the one or more brake pads may be distributed between the inboard and outboard end of the brake caliper via the longitudinal member.

The lateral and longitudinal members may connect or intersect at an intersecting area. The intersecting area may function to provide structure for torque from rotation of the one or more brake pads to be distributed amongst the leading and trailing ends of the brake caliper and the inboard and outboard sides of the brake caliper. The intersecting area may be centered between the inboard and outboard side, the leading or trailing ends, or both. The intersecting area may be offset or closer to one of the inboard or outboard side, the leading or trailing end, or a combination thereof.

The brake caliper may comprise one or more brake pistons. One or more brake pistons may be located at an inboard side of the brake rotor or caliper (i.e., inboard brake piston); one or more brake pistons may be located at an outboard side of the brake rotor or caliper (i.e., outboard brake piston); or a combination thereof. The inboard and outboard brake pads may be identical in structure. The inboard and outboard brake pads may structurally mirror images of each other.

The brake system may include one or more brake pads. The brake caliper may be adapted to support one or more brake pad at the inboard side of the brake rotor and one or more brake pads at the outboard side of the brake rotor.

The one or more brake pads may include a first end and a second end. The first end may be a leading end and the second end may be a trailing end. Over time, the first or leading end may wear more, or wear faster than the second or trailing end. This may be referred to in the art as taper wear. Stated another way, the first or leading end may contact the brake rotor first and/or with a greater force than the second or trailing end. This may cause the first or leading end to wear more, or wear faster, than the second or trailing end.

As was discussed above, various countermeasures sizes are used in the industry to reduce or eliminate such taper wear, such as offsetting the brake pistons towards the trailing end of the brake caliper and/or using different sized brake piston. However, the need for such countermeasures can be reduced or eliminated with these teachings. That is, by providing an upper brake pad abutment that contacts an overhead bridge or lateral member of the brake caliper during forward braking so that the torque from the brake pads is evenly distributed between the leading and trailing ends of the brake caliper, and/or by providing structure so that the brake pads rotate in a single direction during forward and reverse braking, uneven brake pad wear can be reduced or eliminated and the need for countermeasures can be reduced or eliminated.

As used throughout this disclosure, main abutment may refer to an area or contact between the brake pad pressure plate and the brake caliper where all or a majority of the torque is transmitted from the brake pad to the brake caliper during forward or reverse braking. For example, during forward braking, the main abutment is located at the upper abutment where contact is made with a lateral member of the bridge. However, in some configurations, the main abutment may be the leading abutment or the trailing abutment during forward braking.

During reverse braking, the main abutment is at the leading abutment where contact is made with the leading notch in the brake caliper. However, in some configurations, the main abutment may be the upper abutment or the trailing abutment during reverse braking.

The brake system includes pad clips that are adapted to provide forces onto the brake pad to stabilize the brake pad. The pad clips may be biasing members. The pad clips may be springs. The pad clips may help provide for the brake pads to rotate in the same clockwise direction during forward and reverse braking. While the following description and the figures include the pad clips located between the bridge and an upper portion of the brake pads (at the leading and trailing ends), it is understood that other pad clips or biasing members may be utilized and/or their location may be different than what is shown in the figures and described below. For example, one or more of the pad clips may be located under the brake pad and/or between a bottom portion of the brake pads and the brake caliper. One or more of the pad clips may be located between walls of an outer portion of the brake caliper where the brake pistons are contained and the brake pads. One or more of the pad clips may be located at a location where the brake caliper startles the brake rotor.

The brake system may comprise one leading pad clip that is adapted to engage both inboard and outboard brake pads, and the brake system may comprise one trailing end pad clip that is adapted to engage both inboard and outboard brake pads. Alternatively, the brake system may comprise two leading pad clips, each one of which is adapted to engage a respective inboard and outboard brake pad, and the brake system may comprise two trailing pad clips, each one of which is adapted to engage a respective inboard and outboard brake pad.

The leading pad clip may extend under the longitudinal member and apply a downward force onto the leading ends of one or both inboard and outboard brake pads. The leading pad clip may extend over the longitudinal member and apply an upward force onto the leading ends of one or both inboard and outboard brake pads. The trailing end pad clip may extend over the longitudinal member and apply an upward force onto the trailing ends of one or both inboard and outboard brake pads. The trailing pad clip may extend under the longitudinal member and apply a downward force onto the trailing ends of one or both inboard and outboard brake pads.

The leading and/or trailing pad clips may be made of spring steel. The leading and/or trailing pad clips may be biasing members or springs.

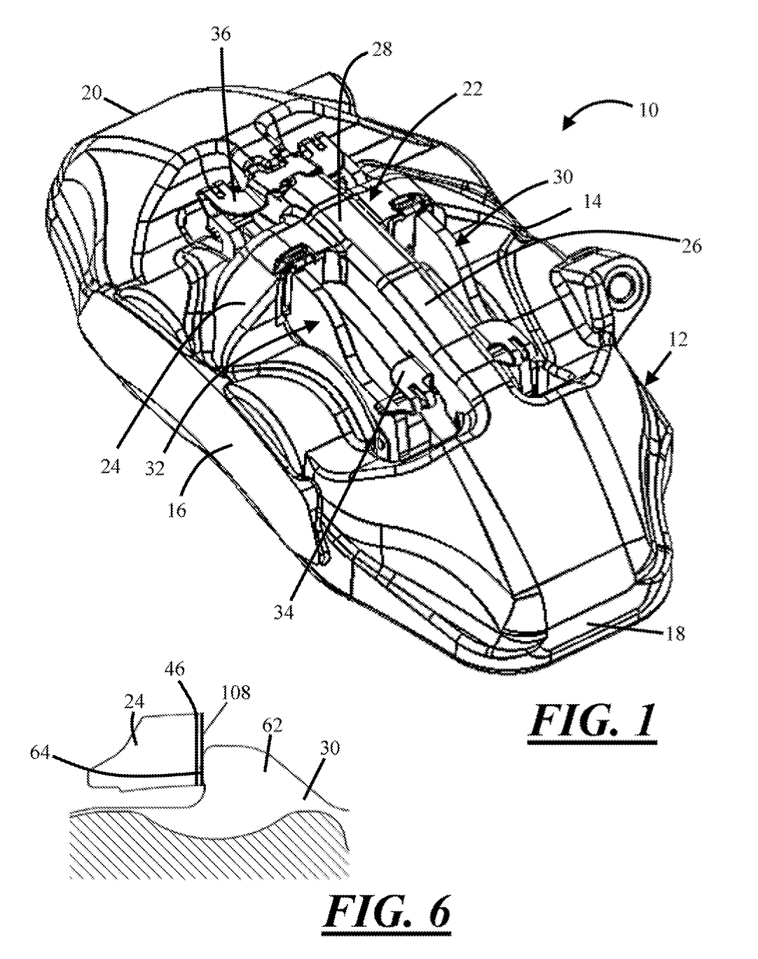

FIG. 1 illustrates a brake system 10. The brake system 10 is a fixed caliper brake system. The brake system 10 comprises a brake caliper 12. The brake caliper 12 comprises an inboard side 14 and an opposing outboard side 16. The brake caliper 12 comprises a leading end 18 and an opposing trailing end 20.

The brake caliper 12 comprises a bridge 22. The bridge 22 comprises a lateral member 24 and a longitudinal member 26. The lateral member 24 extends between and connects the inboard side 14 and the outboard side 16. The longitudinal member 26 extends between and connects the leading end 18 and the trailing end 20. The lateral member 24 connects and/or intersects with the longitudinal member 26 at an intersecting area 28.

The brake caliper 12 is adapted to support an inboard brake pad 30 at the inboard side 14 of the brake caliper 12, and an outboard brake pad 32 at the outboard side 16 of the brake caliper 12.

The brake caliper 12 is also adapted to support one or more brake pistons (FIG. 2) located at the inboard side 14 of the brake caliper 12, and one or more brake pistons located at the outboard side 16 of the brake caliper 12.

The brake system 10 comprises a leading pad clip 34 and a trailing pad clip 36. The leading pad clip 34 is located under the longitudinal member 26, and is adapted to push down or apply a downward force onto the leading ends of the brake pads 30, 32 as will be discussed further below. The trailing pad clip 36 is arranged on top of the longitudinal member 26, and is adapted to pull up or apply an upward force onto the trailing ends of the brake pads 30, 32 as will also be discussed further below.

FIG. 2 is a cross section of the inboard side 14 of the brake caliper 12. While not illustrated, the outboard side 16 may be a mirror image of the inboard side 14. The brake caliper 12 comprises mounting holes 38, 40 for attaching the brake caliper 12 to a non-moving portion of a vehicle, such as a knuckle. The brake caliper 12 comprises brake pistons 42, 44 supported in bores defined in the caliper 12.

The lateral member 24 of the brake caliper 12 comprises a lateral member edge 46 that faces the leading end 18 of the brake caliper 12. The lateral member edge 46 may extend along an axis or plane 48 that is centered or located between the brake pistons 42, 44; centered or located between the leading and trailing ends 18, 20; or both. The brake caliper 12 comprises a leading notch 50 and a trailing notch 52.

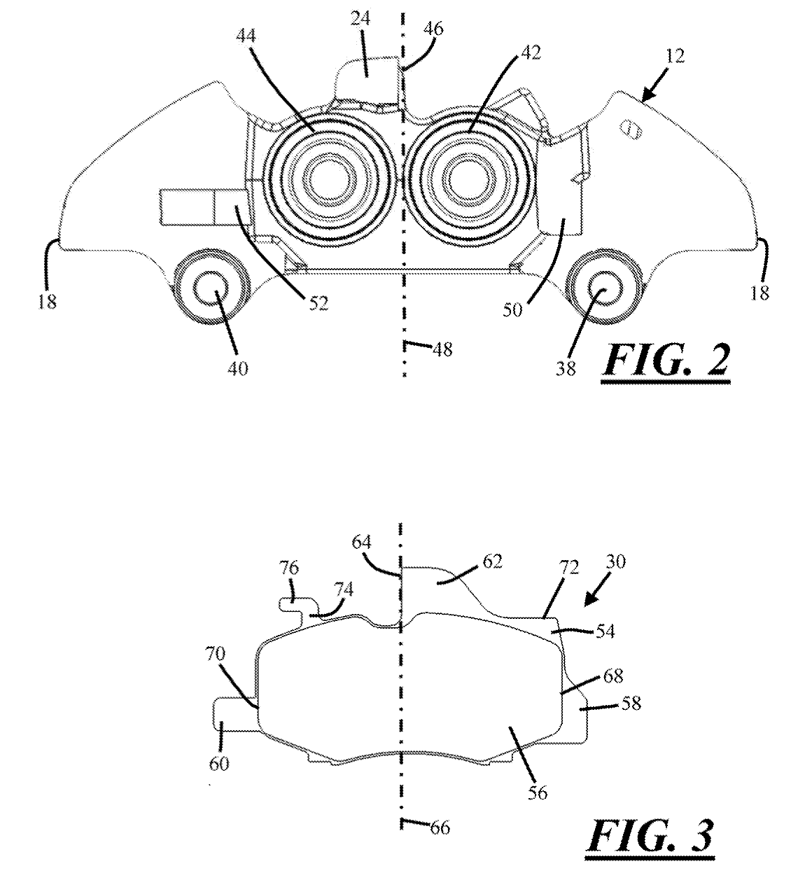

FIG. 3 is a side view of the inboard brake pad 30. The outboard brake pad 32 may be a mirror image of the inboard brake pad 30.

The inboard brake pad 30 comprises a pressure plate 54 and a friction material 56. The inboard brake pad 30 or pressure plate 54 comprises a leading pad abutment 58; a trailing pad abutment 60; and an upper pad abutment 62. The upper pad abutment 62 comprises an upper abutment edge 64 that faces the trailing pad abutment 60 and the trailing end 20 of the brake caliper (FIG. 2) when the brake pad 30 is installed in the caliper 12. The upper abutment edge 64 may extend along an axis or plane 66 that is centered or located between the leading and trailing edge 68, 70 of the friction material 56; the leading and trailing pad abutments 58, 60, or both.

When the inboard brake pad 30 is installed in the brake caliper 12 (FIG. 2), the leading pad abutment 58 is received into and supported in the leading notch 50, and the trailing pad abutment 60 is received into and supported in the trailing notch 52. The upper abutment edge 64 is adapted to contact, engage, face, or be located immediately adjacent the lateral member edge 46 of the brake caliper 12. When the inboard brake pad 30 is installed in the brake caliper 12, the axes or planes 66, 48 may be coaxial or coplanar.

With additional reference back to FIG. 1, when the inboard brake pad 30 is installed in the brake caliper 12, the leading pad clip 34 is adapted to contact and engage a leading engagement area 72 of the pressure plate 54 and apply a downward force thereon. The trailing pad clip 36 is adapted to contact and engage a trailing engagement area 74, which may comprise a cantilever portion 76, and apply an upward force thereon.

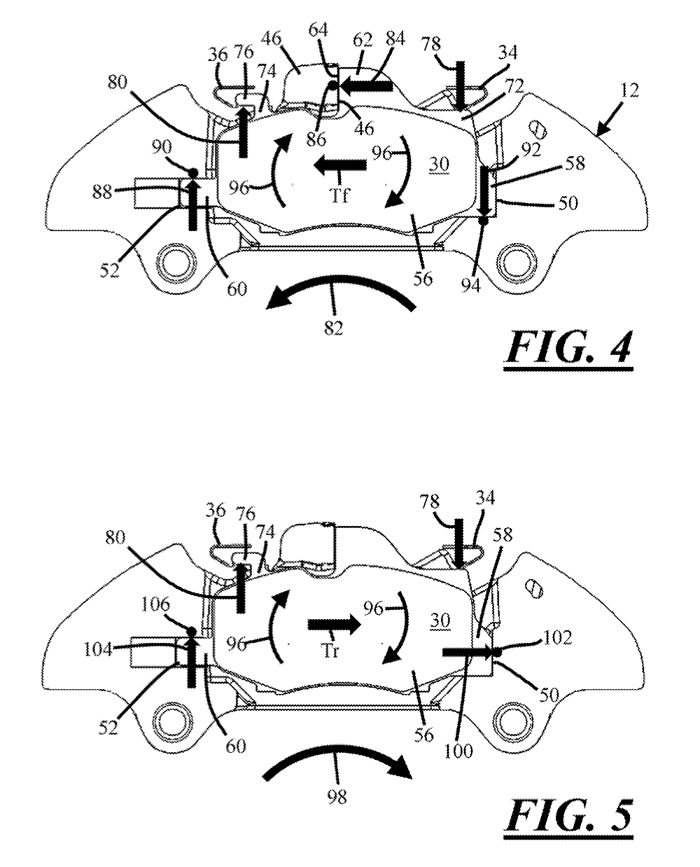

FIG. 4 is a cross-sectional view of the inboard brake pad 30 installed in the brake caliper 12. The leading pad abutment 58 of the brake pad 30 is received into and supported in the leading notch 50 of the brake caliper 12, and the trailing pad abutment 60 of the brake pad 30 is received into and supported in the trailing notch 52 of the brake caliper 12. The upper abutment edge 64 of the brake pad 30 is in contact, engages, faces, or is located immediately adjacent the lateral member edge 46 of the brake caliper 12. The leading pad clip 34 is in contact with the leading engagement area 72 of the pressure plate 30 and is adapted to apply a downward force 78 thereon. The trailing pad clip 36 is in contact with the cantilever portion 76 of the trailing engagement area 74, and is adapted to apply an upward force 80 underneath the cantilever portion 76. By stabilizing the brake pad 30 according to the aforementioned structure, the brake pad 30 will move in a tangential direction (i.e., front to back) during a braking event, but not necessarily in an up and down direction. Stabilizing the brake pad 30 according to the aforementioned structure may advantageously reduce pad wear, and/or reduce noise, vibration, and hardness (NVH).

In FIG. 4, the vehicle is moving in a forward direction (i.e., forward braking) and the brake rotor is rotating in counter-clockwise direction 82. When the friction material 56 of the brake pad 30 is moved against the brake rotor that is rotating in direction 82, a tangential force Tf is applied onto the brake pad 30. The tangential force Tf causes the brake pad 30 move until the edge 64 of the upper pad abutment 62 contacts the lateral member edge 46 of the lateral member 24. A force 84 is applied by the upper pad abutment 62, which is the main abutment during the forward braking, on the lateral member 24 at a contact area 86 between the edge 64 of the upper pad abutment 62 and the edge 46 of the lateral member 24. Due to force 84, and also the forces 78, 80 applied on the brake pad 30 by the respective pad clips 34, 36, a moment 88 is created at a contact area 90 between the trailing pad abutment 60 and the trailing notch 52. Another moment 92 is created at a contact area 94 between the leading pad abutment 58 and the leading notch 50. The moments 88, 92 are forces that causes the brake pad 30 to rotate. Accordingly, during a forward braking event, the brake pad 30 rotates or pivots in a clockwise direction 96. As can be seen and appreciated, during the forward braking, the clockwise rotation 96 of the brake pad 30 is the same as the direction of the forces 78, 80 applied on the brake pad 30 via pad clips 34, 36.

As was briefly discussed above, the edge 64 of the upper pad abutment 62 that contacts the edge 46 of the lateral member 24 of the bridge 22 is located generally between the edges 68, 70 of the friction material 56 of the brake pad 30 and/or abutment ends of the brake pad 30. The location advantageously allows for the brake pad 30 to rotate or pivot in the clockwise direction 96 during forward braking when the brake rotor rotates in a counter-wise direction 82. Moreover, because the upper pad abutment 62 is the main abutment during the forward braking, a majority of the torque from the pad 30 is applied on the bridge 22, which is then distributed between the inboard side 14, the outboard side 16, the leading end 18, and the trailing end 20 of the brake caliper 12 via the lateral member 24 and longitudinal member 26 of the bridge 22. This force distribution advantageously distributes the torque from the brake pad 30 to the entire brake caliper 12 instead of to just one side or one end of a brake caliper as may be seen in other brake calipers known in the art.

Referring now to FIG. 5, during a braking event when the vehicle is moving in a reverse direction (i.e., reverse braking), the brake rotor is adapted to rotate in a clock-wise direction 98. As the friction material 56 of the brake pad 30 is moved against the brake rotor rotating in direction 98, a tangential force Tr is applied on the brake pad 30. Due to the tangential force Tr, a force 100 is applied by the leading pad abutment 58, which is the main abutment during a reverse braking event, on the leading notch 50 at a contact area 102 between the leading pad abutment 58 and the leading notch 50. As a result of force 100, and the forces 78, 80 applied on the brake pad 30 by the respective pad clips 34, 36, a moment 104 is created at a contact area 106 between the trailing pad abutment 60 and the trailing notch 52. The moments 104 is a force that causes the brake pad 30 to rotate. Therefore, during a reverse braking event, the brake pad 30 rotates in a clockwise direction 96 just like during a forward braking event illustrated in FIG. 4. Similarly, during the reverse braking, the clockwise rotation direction 96 of the brake pad 30 is the same as the direction of the forces 78, 80 applied on the brake pad 30 via pad clips 34, 36.

Referring to FIG. 6, a pad clip 108 may be located at a contact area between the edge 46 of the lateral member 24 and the edge 64 of the upper pad abutment 62 of brake pad 30. The clip 108 may be attached to either edge 46 or 64. The clip 108 may function to prevent wear to the pad 30 or caliper 12 as the pads 30 rotate during a braking event. The edge 64 of the upper abutment 62 and/or edge 46 of the lateral member 24 may include a rounded portion or radius edge 110 for stable contact with the lateral member 24 of bridge 22 or the clip 108 during a forward braking event; however, the edge 64 may also be generally linear or flat.

It is understood that while the above-mentioned description is focused on the inboard brake pad 30, the same teachings also apply to the outboard brake pad 32. That is, during forward braking, the main abutment of the outboard brake pad 32 is the upper pad abutment 62, and during the reverse braking, the main abutment is the leading pad abutment. Moreover, during forward braking and reverse braking, the outboard brake pad 32 is supported such that it rotates in a clockwise direction, regardless of rotor rotation.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

By use of the term “may” herein, it is intended that any described attributes that “may” be included are optional.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The disclosures of all articles and references, including patent applications and publications, are incorporated by reference for all purposes. Other combinations are also possible as will be gleaned from the following claims, which are also hereby incorporated by reference into this written description.

### LISTING OF REFERENCE NUMERALS

10 brake system
12 brake caliper
14 inboard side
16 outboard side
18 leading end
20 trailing end
22 bridge
24 lateral member
26 longitudinal member
28 intersecting area
30 inboard brake pad
32 outboard brake pad
34 leading pad clip
36 trailing pad clip
38 mounting hole
40 mounting hole
42 brake piston
44 brake piston
46 lateral member edge
48 axis or plane
50 leading notch
52 trailing notch
54 pressure plate
56 friction material
58 leading pad abutment
60 trailing pad abutment
62 upper pad abutment
64 upper abutment edge
66 axis or plane
68 leading edge of friction material
70 trailing edge of friction material
72 leading engagement area
74 trailing engagement area
76 cantilever portion
80 upward force
82 counter-clockwise rotation of rotor
84 force
86 contact area
88 moment
90 contact area
92 moment
94 contact area
96 clockwise direction of pad 30
98 clockwise direction rotation of rotor
100 force
102 contact area
104 moment
106 contact area
108 clip

1) A brake caliper comprising:
an inboard side;
an outboard side; and
a bridge comprising a lateral member that connects the inboard side and the outboard side,
wherein the brake caliper is adapted to support a brake pad, the brake pad comprises an upper pad abutment, and
wherein during a braking event when a brake rotor rotates in a counter-clockwise direction, the upper pad abutment is adapted to contact the lateral member so that the brake pad rotates in a clockwise direction and toque acting on the brake pad is distributed from the brake pad to both the inboard side and the outboard side of the brake caliper via the lateral member.

2) The brake caliper of claim 1, wherein the brake caliper comprises a leading end and a trailing end, and the bridge includes a longitudinal member that connects the leading end and the trailing end, the lateral member intersects with the longitudinal member, and
wherein during the braking event when the upper pad abutment contacts the lateral member, the torque acting on the brake pad is distributed to both the leading end and the trailing end of the brake caliper via the longitudinal member.

3) The brake caliper of claim 2, wherein a leading pad clip is located under the longitudinal member and is adapted to apply a downward force onto the brake pad, and
wherein a trailing pad clip is arranged on top of the longitudinal member and is adapted to apply an upward force onto a trailing engagement area the brake pad.

4) The brake caliper of claim 2, wherein the brake caliper comprises a leading notch and a trailing notch,
wherein the brake pad includes a leading pad abutment and a trailing pad abutment, and
wherein the leading pad abutment is received into and supported by the leading notch, and the trailing pad abutment is received into and supported by the trailing notch, and
wherein during forward braking, the upper pad abutment is the main abutment, and during reverse braking the leading pad abutment is the main abutment.

5) The brake caliper of claim 4, wherein the upper pad abutment is generally centered between a leading edge and a trailing edge of a friction material of the brake pad.

6) The brake caliper of claim 1, wherein the lateral member comprises a lateral member edge, the upper pad abutment is adapted to contact the lateral member edge during the braking event, the lateral member edge is generally centered between a leading end and a trailing end of the brake caliper.

7) The brake caliper of claim 6, wherein the upper pad abutment is adapted to contact the lateral member edge during both forward braking and reverse braking.

8) A brake pad comprising:
friction material;
a leading pad abutment;
a trailing pad abutment; and
an upper pad abutment, the upper brake pad abutment comprises an upper abutment edge that is generally centered between a leading and trailing edge of the friction material;
wherein the leading pad abutment is adapted to be received into a leading notch of a brake caliper and the trailing pad abutment is adapted to be received into a trailing notch of the brake caliper, and
wherein during a braking event, the upper brake pad abutment is adapted to contact a bridge of the brake caliper that extends between an inboard side of the brake caliper and the outboard side of the brake caliper so that as the brake pad rotates during the braking event, and torque from the brake pad is distributed between the inboard side of the brake caliper and the outboard side of the brake caliper via the bridge.

9) The brake pad of claim 8, wherein the brake pad rotates in the same direction during forward braking and during reverse braking.

10) The brake pad of claim 8, wherein the brake pad includes a leading engagement area and a trailing engagement area,
wherein a downward force is applied onto the leading engagement area by a pad clip, and
wherein an upward force is applied on the trailing engagement area by another pad clip, and
wherein the upward force and the downward force are the same direction as the rotation of the brake pad during the braking event.

11) The brake pad of claim 10, wherein the trailing engagement area includes a cantilever portion, the another pad clip is adapted to provide the upward force underneath the cantilever portion.

12) A brake system, comprising:
a brake caliper, the brake caliper comprises a bridge, the bridge comprises a lateral member that connects an inboard side of the brake caliper and an outboard side of the brake caliper, and
a brake pad, the brake pad includes an upper pad abutment, and
wherein during forward braking, the brake pad rotates in a direction that is opposite a direction of rotation of a brake rotor until that the upper pad abutment contacts the lateral member of the brake caliper and torque from the brake pad is distributed from the brake pad to the inboard side the outboard side via of the brake caliper via the lateral portion.

13) The brake system of claim 12, wherein the brake caliper includes a leading end and a trailing end, and the bridge includes a longitudinal member that connects the leading end, the trailing end, and the lateral member, and
wherein during the forward braking when the upper pad abutment contacts the lateral member, the torque is distributed from the brake pad to the leading end and the trailing end of the brake caliper via the longitudinal member.

14) The brake system of claim 12, wherein the brake system includes a leading pad clip and a trailing pad clip,
wherein the leading pad clip is adapted to provide a force on a leading engagement area of the brake pad, and the trailing pad clip is adapted to provide a force on a trailing engagement area of the brake pad, and
wherein during the forward braking, the forces on the leading engagement area and the trailing engagement area are provided in the same direction that the brake pad rotates.

15) The brake system of claim 14, wherein the force acting on the leading engagement area of the brake pad is a downward force, and the force acting on the trailing engagement area of the brake pad is an upward force.

16) The brake system of claim 14, wherein during the forward braking and reverse braking, the brake pad rotates in the same direction.

17) The brake system of claim 16, wherein during both the forward braking and the reverse braking, the brake pad rotates in a clockwise direction.

18) The brake system of claim 12, wherein the brake pad includes a leading pad abutment and a trailing pad abutment, and the brake caliper includes a leading notch and a trailing notch,
wherein the leading pad abutment is received in the leading notch and the trailing pad abutment is received in the trailing notch so that the brake pad is supported in the brake caliper,
wherein during the forward braking, the upper pad abutment is a main abutment, and
wherein during reverse braking, the leading pad abutment is the main abutment.

19) The brake system of claim 18, wherein the brake system is a fixed caliper disc brake system.

20) The brake system of claim 12, wherein the lateral member comprises a lateral member edge, the lateral member edge is generally centered between a leading end and a trailing end of the brake caliper,
wherein the upper pad abutment contacts the lateral member edge during the braking event, and
wherein the upper pad abutment is generally centered between a leading edge and a trailing edge of a friction material of the brake pad.
